(19) United States
(12) Patent Application Publication
(10) Pub. No.: US 2008/0314105 A1
(43) Pub. Date: Dec. 25, 2008

(54) Pin tumbler key lock assembly

(75) Inventors: Kermit Lawson, Tarboro, NC (US); T. Michael Phillips, Rocky Mount., NC (US); Tom Boone, Sharpsburg, NC (US); Douglas G. Davis, Rocky Mount., NC (US)

Correspondence Address: DENNIS A. GROSS;D|B|A THE HILL FIRM, 666 DUNDEE RD, SUITE 1201, NORTHBROOK, IL, 60062, US

(73) Assignee: Kaba Ilco Corp.

(21) Appl. No.: 11/820,321

(22) Filed: Jun. 20, 2007

(51) Int. Cl. E05B 27/00

(52) U.S. Cl. 70/493; 70/357

(57) ABSTRACT

A headed pin for use in pin tumbler locks is provided with a release diameter cylindrical body having an enlarged diameter axially short head at one end, the reduced diameter body being received internally of a biasing spring which bottoms against an underside of the head, the spring extending beyond the end of the cylindrical body opposite the head, and the headed pin and spring being received in one or more of the pinholes as the upper pin in a pin tumbler lock.

### FIELD OF THE INVENTION

This invention relates to pin tumbler cylinder locks and to pin configurations.

### BACKGROUND OF THE INVENTION

Normal rotating cylinder, pin tumbler key lock assemblies consist of a cylinder received in a lock body bore having an entrance face substantially flush with the lock body face. The cylinder has a key slot milled into it from its outer face longitudinally of the cylinder. The slot may be provided with wards limiting the type key blade which may be received in the slot. The cylinder is rotatable in the lock body and is provided with a series of longitudinally spaced pinholes extending radially of the key slot and open to the slot and to the cylinder O.D. The pinholes line up with a similar series of spaced pinholes in the lock body above the cylinder. A shear line exists between the rotating cylinder and the lock body bore receiving the cylinder. In the normal locked position pins in each pinhole span the shear line preventing rotation of the cylinder in the lock body.

Each pinhole combination of cylinder pinhole and lock body pinhole receives at least a pair of pins, generally referred to as a lower pin and an upper pin. The pinholes in the lock body are closed at one end remote from the cylinder and a spring is entrapped between the upper pin received in that pinhole and the closed end or bottom of the pinhole. This spring then biases the upper pin into contact with the lower pin pushing both pins into the cylinder pinhole. The cylinder pinholes, where they intersect with the key slot have a larger diameter than the cross section of the key slot such that the lower pins cannot pass entirely into the key slot, thereby retaining the lower pin in the lock, however, positioned substantially within the cylinder. Upon insertion of the key into the key slot, the pin engaging edge of the key will push the lower pins against the upper pins moving the lower and upper pins against the spring pressure a distance determined by the bitting cut into the key edge. When a properly bitted key is fully inserted into the cylinder, usually determined by an abutment of a shoulder on the key head with an exterior face of the lock, the various bittings or cuts in the pin engaging edge of the key will be aligned with the lower pins in the respective pinholes, and the lower pins will be lifted a distance determined by the depth of cutting of the bitting on the key blade.

When a properly bitted key is received in its appropriate lock, the bitting will raise the lower pins so that the ends of each of the lower pins and the bottom end of the respective upper pin will lie along the shear line and the cylinder will be able to be rotated by rotating the key. The pins are of different lengths so that the bitting must move some pins a greater distance than other pins.

When an improperly bitted key is inserted into the lock, one or more of the pin sets will not be moved against the spring pressure to the proper distance and therefore either the upper pin or the lower pin will extend across the shear line preventing rotation of the cylinder.

Because standard pin tumbler locks employ a multiplicity of pinholes, normally five or more, the compressive force of the springs used to exert pressure against the pins is relatively low for two reasons. First, it is desired to keep the overall height of the lock within acceptable limits and therefore the space available above the upper pin for receipt of the spring is limited. Second, it is desired to allow easy insertion of the key into the lock. Thus, the force necessary to move the pins axially in the pinholes against the spring is relatively minor.

While such pin tumbler locks offer an acceptable degree of security in most instances, there are known methods of opening such locks without having a properly bitted key. Some methods, such as picking the lock, require considerable skill and training and are generally not a concern for most installations.

There exists, however, one known brute force method of opening a pin tumbler lock known as “key bumping.” While this technique, which will not be described here, has been known to professional locksmiths for a considerable period of time, that knowledge was generally not widespread. Recently, with the advent of the worldwide web, instructions on key bumping have become widely available to anybody. Since key bumping will work with many standard pin tumbler locks, and does not require proper bitting of the key, it would be an improvement in security of the locks to provide a key bumping resistant standard pin tumbler lock.

### SUMMARY OF THE INVENTION

This invention overcomes disadvantages in prior art standard pin tumbler locks and provides a modification which is retrofittable into existing locks which reduces the ability to open the lock by key bumping techniques.

In the preferred embodiment an upper pin, which is headed in the manner of a nail, is provided. The pin consists of a cylindrical body portion of smaller diameter than the pinhole, the body portion having an axial length and having at one end thereof an enlarged diameter section or head, which is of relatively short axial length and which has an outer diameter of generally standard pin dimension for the pinhole. A coil spring is received around the cylindrical body portion and bottomed against the under surface of the head. The coil spring extends beyond the axial end of the body portion remote from the head in its free state. The headed pin and coil spring are received in the lock body pinhole, and the overall dimensioning is such that when the cylinder pinholes are aligned with the lock body pinholes, the head of the pin will extend beyond the shear line into the cylinder pinhole with the end of the coil spring opposite the head bottomed against or adjacent to the blind end of the lock body pinhole and with the coil spring being either in a slightly compressed or generally uncompressed condition. The spring, since it is received around the cylindrical body portion, can therefore be longer and stiffer than springs in other pinholes which bottom against the upper pins top.

Surprisingly, it has been found that by providing such a headed upper pin and coil spring positioned around a reduced diameter portion and bottomed against the undersurface of the head, that the resultant pin tumbler cylinder lock will be highly resistant to key bumping since the bumping pressure exerted against the lower pin associated with the headed pin will be insufficient to cause the headed pin's head bottom to lift to the shear line. The pin of this invention can be retrofitted into existing locks or provided in new locks. More than one such pin may be used in a lock.

It is therefor an object of this invention to provide an improved pin tumbler lock employing a headed upper pin which is resistant to key bumping.

It is another and more specific object of this invention to provide a key bump resistant pin tumbler cylinder lock having a headed pin with a reduced diameter portion projecting from the pin head, the reduced diameter portion surrounded by a coil spring bottomed against an under surface of a pin head.

It is another and more specific object of this invention to provide an improved key bumping resistant pin tumbler cylinder lock retrofit comprising a headed pin having an enlarged head portion at one end of a cylindrical body portion, the head having an outer diameter approximately normal for pins received in upper pinholes in such locks, the cylindrical body portion having a smaller diameter than the pin head and projecting therefrom, a coil spring received around the cylindrical body portion and extending beyond an end of the cylindrical body portion remote from the head, the coil spring being bottomed against the undersurface of the head of the pin.

It is another of this invention to provide a unique pin and coil spring combination for use in pin tumbler cylinder locks having pinholes for receipt of pins, the unique pin having a head of relatively short axial distance and a diameter approximately normal for receipt in normal pinholes, a projecting cylindrical body portion extending from an under surface of the pin head, a coil spring received around the body portion and bottomed against an under surface of the pin head, the coil spring extending beyond an axial end of the body portion remote from the head, the coil spring having an outer diameter approximately the same as the diameter of an upper pin or spring which would be normal to the pinhole of the lock.

Other objects, features and advantages of this invention will be apparent to those of ordinary skill in the art from the following detailed description of a preferred embodiment.

### DESCRIPTION OF THE DRAWINGS

FIG. 1 is an exploded partially sectional view of a standard prior art pin tumbler cylinder lock and associated key.

FIG. 2 is an enlarged view of a pin tumbler cylinder lock provided with the pin of this invention.

FIG. 3 is a view similar to FIG. 2 showing the pin positions upon insertion of a properly bitted key.

FIG. 4 is a view of a pin according to this invention and a coil spring in its uncompressed condition.

FIG. 5 is a view similar to FIG. 4 showing a coil spring in its compressed condition.

FIG. 6 is an exploded view of FIG. 4.

### DESCRIPTION OF THE PREFERRED EMBODIMENT

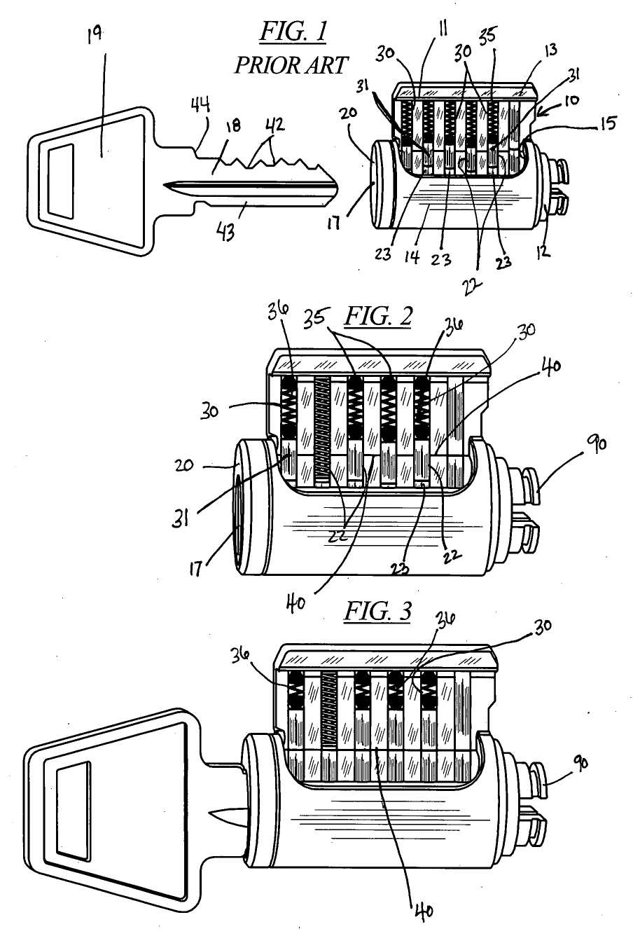

A standard pin tumbler cylinder lock is shown in FIG. 1 and includes a lock assembly 10 consisting of a lock housing 11 defining a lock body, which receives a rotatable cylinder 12. The lock body includes an upper portion 13 and a lower body portion 14 which has a bore 15 therethrough for receipt of the rotatable cylinder 12. The cylinder is retained in the body portion 14 in a number of different known ways and includes a key slot 17 for receipt of the blade 18 of a key 19. The key slot 17 extends from a front face 20 which is normally aligned with the front of the body 14 substantially along the entire length of the cylinder. The key slot intersects with a plurality of spaced pinholes 22 in the cylinder in which are received lower pins 23. The pins 23 are axially shorter than the cylinder pinholes, may include more than one pin and have a major outer diameter approximately equal to the pinhole in which they are received but allowing freedom of axial movement of the lower pin within the pinhole and a length sufficient to prevent canting in the hole. The pins or stack of pins are of differing axial lengths in different holes. The upper body portion 13 of the housing also includes a series of pinholes 30 which receive upper pins 31, which also have freedom of axial movement and an axial length preventing canting. The pinholes 30 are closed at a top 35 and springs 36 are trapped between the upper pins 31 and the top 35. The springs urge the upper pins against the lower pins. Where the cylinder outer diameter and the body bore inner diameter mate is known as the shear line, and the upper pinhole bores and lower pinhole bores are alignable so that they communicate with one another across the shear line. Because the lower pins are of different axial lengths, the upper pins will, when the pinholes are aligned, extend across the shear line 40 in differing degrees preventing rotation of the cylinder within the lock body. Upon insertion of a proper key blade having bittings 42, which correspond in height above the key blade reference point such as the key blade bottom 43 to the axial distance of the lower pin top from the shear line when the lower pin is in its bottom most position, the pins will be raised. When the shoulder 44 of the key blade abuts against the front face 20 of the cylinder, the bittings of the key blade will be properly aligned with their appropriate lower pins. This will cause the juncture of the lower pins and upper pins to lie along the shear line and therefore allow rotation of the cylinder. As is well known the top pin bottoms and the lower pin tops may be configured to facilitate cylinder rotation at that point. The distal end of the cylinder may have connecting means 90 to slide the lock bolt in and out upon rotation of the cylinder.

While such pin cylinder locks are extremely common and provide adequate security in most instances, there is a known technique called key bumping which employs a key not having bittings cut to properly mate with the varying axial dimensions of the lower pins but which, in certain circumstances, can be used to open a standard pin cylinder lock. Key bumping causes the upper and lower pins to move into position with respect to the shear line such that by application of high torque to the key, the pins can be held in position to allow the lock to be opened.

This invention uses a headed pin and coil spring assembly 50 in at least one of the upper bores 30 to resist key bumping. The headed pin 51, best shown at FIG. 6, consists of a reduced cross section body portion 52 having an enlarged diameter head 53 at one axial end thereof. The head 53 is relatively axially short in comparison to standard upper pins. The reduced cross section body portion 52 is preferably cylindrical and has a reduced diameter in comparison to the head 53. The head 53 O.D. may be of normal dimension for upper pins for the particular lock. The overall length of the head and reduced diameter body portion 52 may approximate the length of standard upper pins. Because of the reduced diameter body portion 52, a coil spring 60 having a length and cross section diameter of the spring coils considerably greater than the length and coil thickness normally utilizable with upper pins is provided. The coil has an inner diameter 61 which receives the reduced diameter portion 52 and prevents canting of the pinhead and an outer diameter approximately equal to or slightly greater than the outer diameter of the head 52. The outer diameter 64 of the coil spring is adapted to fit within the standard upper and lower pinholes of the lock, it being understood that different locks have different sized pinholes. The diameter of the headed portion 53 is approximately the same diameter as normal for upper pins. Therefor it will be understood that the outer diameter of the coil spring 60 is approximately the same as the diameter of the head but may be larger or smaller or equal, as long as it is able to fit loosely in the pin holes in both the lock body and the cylinder, all of which are considered to be approximately the same as the pinhead diameter.

Because the spring can be longer than normal, since it extends all the way to the upper surface 54 of the head, and because it can be generally stiffer than standard pin springs, the resistance to movement of the pin assembly 50 is greater than normal pin assemblies. 5 Preferably the overall pin and spring assembly 50 will be such that in the uncompressed or slightly compressed condition of the spring the pin will project into the cylinder pinhole, in the absence of key, as will a length of the spring 60. In this manner, the spring itself acts as an anti-rotation element substantially the same as upper pins. The length of the reduced diameter section 52 is short enough to allow full travel of the pin 51 to the shear line point where the under surface 55 of the pin 51, lying in contact with and opposition to its associated lower pin will be positioned along the shear line as shown in FIG. 3.

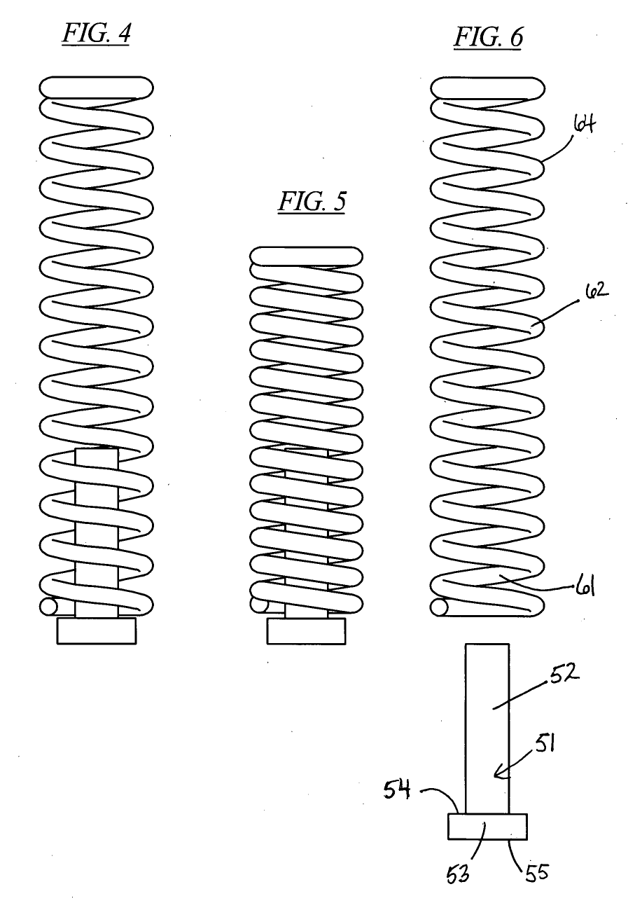

Surprisingly it has been determined that the use of a headed pin and spring combination such as shown in FIGS. 4-6, when received in an upper pinhole as shown in FIGS. 2 and 3, will provide a lock assembly having a greater resistance to key bumping than lock assemblies employing normal upper pin and spring designs. The resistance to key bumping has been determined to exist with as few as one of the headed pin and spring combinations 50, although it is clear that more than one could be used in a lock if desired. Although the force necessary to move the headed pin to the shear line position shown in FIG. 3 from its rotation preventing position shown in FIG. 2 is greater than the force necessary to move the remaining upper pins, due to the added strength of the spring, it is not believed that that adds a sufficiently greater resistance to insertion of the key that the degree of added force would be noticeable to ordinary users.

It will be apparent to those of ordinary skill in the art that the particular dimensions both axially and radially of the spring, the reduced diameter section 52 and the head 53 as well as the axial length of the spring can be subject to modification to properly fit and work within a given lock. Other variations of this invention are also within the level of ordinary skill of persons within the art, and for example instead of a coil spring, and compressible elastomaric material spring can be used having a bore for receipt of the reduced diameter section 52.

We claim as our invention:

1. A pin tumbler cylinder lock having a rotatable cylinder received in a lock body with the lock body and cylinder having alignable upper and lower pinholes, the upper pinholes being closed remote from the lower pinholes to form blind bore pinholes having a length, the lower pinholes being open to a key slot extending longitudinally of the cylinder, and pins received in the upper and lower pinholes, lower pins in the lower pinholes having a stack height less than the distance from the bottom of a lower pinhole open to the key slot to a shear line at the point where an outer diameter of the cylinder is opposed by an inner diameter of a bore in the lock housing receiving the cylinder, and where upper pins in the upper pinholes are spring biased by springs positioned between the upper pins and the ends of the blind bore pinholes into the lower pinholes with the upper pins positioned across the shear line and engaging lower pins to prevent rotation of the cylinder in a cylinder locked condition until they are lifted by the lifting of the lower pins from a seated position in the key slot as a result of engagement of the lower pins with a bitted edge surface of a key inserted into the key slot in a cylinder unlocked condition, the improvement of at least one of said upper pins comprising a headed pin having a reduced dimension main body portion extending from a pin head at one end of the main body portion, the pinhead having upper and lower head surfaces and being dimensioned to be received in a first upper pinhole, the main body portion having a smaller cross section than the head, a first coil spring positioned in the first upper pinhole around the main body portion the first coil spring bottomed against a top upper surface of the head, the first coil spring having a length greater than the length of the first pinhole, the head in the seated position located entirely in the first lower pinhole aligned with the first upper pinhole, the first coil spring biasing the head out of the upper pinhole across the shear line and into the first lower pinhole and into engagement with an associated lower pin when the upper and lower pinholes are aligned, the spring extending across the shear line from the upper pinhole to the lower pinhole when the head engages the associated lower pin and the associated lower pin is fully seated in the key slot.

2. The lock of claim 1 wherein the headed pin main body portion is cylindrical, the pinhead is cylindrical and the main body portion has a smaller diameter than the diameter of the head, the coil spring has an outer diameter approximately equal to an outer diameter of the pinhead and an inner diameter receiving the main body portion when the pin head is fully received in the upper pinhole.

3. The lock of claim 2 wherein the main body portion has an axial length less than the distance from the lower surface of the pinhead to a blind end of the upper pinhole whereby the pinhead may be completely positioned in the upper pinhole.

4. (canceled)

5. A pin tumbler cylinder lock having a lock body with a bore therethrough for receipt of a cylinder, a cylinder received in the bore, the cylinder and lock body having alignable pinholes, the pinholes of the lock body having blind ends remote from the cylinder and having a length from the blind end to the bore, the pinholes of the cylinder having ends remote from the lock body pinholes open to a key slot in the cylinder, pins received in the lock body pinholes and in the cylinder pinholes, springs positioned in the lock body pinholes behind the pins urging the lock body pins towards the cylinder, the juncture of the outer diameter of the cylinder and the inner diameter of the lock body bore forming a shear line, the pins in the cylinder pinholes having a stack height less than a dimension from the bottom of the cylinder pinhole to the shear line whereby the springs urge the upper pins across the shear line and into the lower pinholes while being partially retained in the lock body pinholes in a cylinder locked position whereby the upper pins span the shear line preventing rotation of the cylinder in the lock body, the improvement of at least one of the upper pins being a headed pin having a short axial length head at one end with a reduced diameter body projecting from the head into a pinhole in the lock body, a first coil spring positioned between the blind end of a first lock pinhole and the head of the pin and engaging an undersurface of the pinhead biasing the pinhead towards the cylinder, the first coil spring having a greater coil cross section diameter than springs in other pinholes of the lock, the first coil spring having a length greater than the first lock pinhole and the first coil spring spanning the shear line from the blind end into a cylinder pinhole when the cylinder and lock body pinholes are aligned and the headed pin's outer end face is engaging its associated cylinder pinhole pin whereby the coil spring spans the shear line preventing rotation of the cylinder, until the first coil spring and associated headed pin is lifted by a bitted key to an unlocked position with the head of the headed pin in the upper pinhole.

6. The lock of claim 5 wherein the first coil spring is longer and more compression resistant than the other spring in the lock.
